(19) United States
(12) Patent Application Publication
(10) Pub. No.: US 2007/0103083 A1
(43) Pub. Date: May 10, 2007

(54) DISCHARGE LIGHT-EMITTING DEVICE

(75) Inventors: Tomio Ono, Kanagawa (JP); Tadashi Sakai, Kanagawa (JP); Naoshi Sakuma, Kanagawa (JP); Hiroaki Yoshida, Kanagawa (JP); Mariko Suzuki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/467,439

(22) Filed: Aug. 25, 2006

(30) Foreign Application Priority Data
Nov. 4, 2005 (JP) 2005-321388

(51) Int. Cl. H01J 61/12; H01J 17/20

(52) U.S. Cl. 313/637

(57) ABSTRACT

A discharge light-emitting device includes an outer envelope filled with discharge gas and a pair of electrodes contained in the outer envelope is provided. At least one of the electrodes includes an electrically conductive substrate, an n-type semiconductor layer provided on the substrate, and a p-type diamond layer provided on the n-type semiconductor layer.

### CROSS-REFERENCE TO RELATED APPLICATIONS

This application is based upon and claims the benefit of priority from the prior Japanese Patent Application No. 2005-321388, filed on Nov. 4, 2005; the entire contents of which are incorporated herein by reference.

### BACKGROUND OF THE INVENTION

1. Field of the Invention

The present invention relates to a discharge light-emitting device that emits light due to discharge using a cathode.

2. Description of the Related Art

Conventionally, high-pressure gas discharge lamps (for example, see Japanese Patent Application Laid-Open No. H06-203805) and low-pressure gas discharge lamps (for example, see Japanese Patent Application Laid-Open No. 2005-108564) are known as discharge light-emitting devices.

Recently, the high-pressure gas discharge lamp is used as a car headlight, a liquid crystal projector, and the like. Further, there are increasing demands in the use of the low-pressure gas discharge lamp as a liquid crystal backlight light source.

However, it is required to raise inner temperature of a lamp to approximately 1000° C. in order to evaporate mercury inside the high-pressure gas discharge lamp. Further, the high-pressure gas discharge lamp uses arc discharge in which thermionic emission from a cathode is performed. Consequently, cathode surface inside the high-pressure gas discharge lamp gains a high temperature of approximately 2000 to 3000° C. since the thermionic emission occurs at the cathode surface. Thus, a problem is caused, for example, in a high intensity discharge (HID) lamp, lamp efficiency gradually decreases because the lamp is placed in chemically severe environment having a high temperature. The environment causes cathode material to evaporate, and the evaporated cathode material adheres to an inner wall of the HID lamp to lower the lamp efficiency.

Further, secondary electron emission by ions is performed in the discharge lamp that uses discharge of the low-pressure gas. Life span of such a discharge lamp is limited by depletion of the cathode, and electron emission efficiency of the cathode influences overall luminous efficiency. Thus, reduction of the depletion of the cathode and improvement of the electron emission efficiency are demanded for the discharge lamp.

It may be possible to use the thermionic emission, which is an electron emission mechanism with higher emission efficiency than the secondary electron emission by ions, to increase the electron emission efficiency at the cathode. However, such a hot cathode lamp is not used as a light source of a backlight and the like, mainly because the hot cathode lamp requires a heating filament and is difficult to process into thin cylinder. Further, even if the hot cathode discharge lamp could be processed into a thinner cylinder through a secondary process, there still remains a problem that it is difficult to extend life span of the hot cathode lamp. Because oxide, such as BaO, having a small work function is applied to the heating filament as a hot cathode material, and depleted due to evaporation and sputtering by the ions.

### SUMMARY OF THE INVENTION

According to one aspect of the present invention, a discharge light-emitting device includes an outer envelope filled with discharge gas; and a pair of electrodes provided in the outer envelope, at least one of the electrodes including an electrically conductive substrate, an n-type semiconductor layer provided on the substrate, and a p-type diamond layer provided on the n-type semiconductor layer.

According to another aspect of the present invention, a discharge light-emitting device includes an outer envelope filled with discharge gas; and a pair of electrodes including an electrically conductive substrate, an n-type semiconductor layer provided on the substrate, and a p-type diamond layer provided on the n-type semiconductor layer so as to expose a portion of the n-type semiconductor layer.

### BRIEF DESCRIPTION OF THE DRAWINGS

FIG. 1 is a cross-sectional view schematically showing a configuration of a discharge light-emitting device according to a first embodiment;

FIG. 2 is a cross-sectional view schematically showing the state between a cathode and an anode after starting discharge, in the discharge light-emitting device according to the first embodiment;

FIG. 3 is a cross-sectional view schematically showing the state between the cathode and the anode after a certain time-interval lapsed from the start of the discharge in the discharge light-emitting device according to the first embodiment;

FIG. 4 is a cross-sectional view schematically showing a configuration of a discharge light-emitting device according to a second embodiment;

FIG. 5 is a cross-sectional view showing an anode and a cathode, which are different from those schematically shown in the second embodiment, in the discharge light-emitting device of the second embodiment;

FIG. 6 is a cross-sectional view schematically showing the cathode of the discharge light-emitting device according to the second embodiment;

FIGS. 7A to 7C are schematic diagrams showing a production process of the cathode provided in the discharge light-emitting device according to the second embodiment;

FIG. 8 is a cross-sectional view schematically showing a configuration of a discharge light-emitting device according to a third embodiment;

FIGS. 9A to 9E are schematic diagrams showing a production process of an electrode of the discharge light-emitting device according to the third embodiment;

FIG. 10 is a cross-sectional view schematically showing a configuration of a discharge light-emitting device according to a fourth embodiment; and

FIG. 11 is a cross-sectional view schematically showing an electrode in the discharge light-emitting device according to the fourth embodiment.

### DETAILED DESCRIPTION OF THE INVENTION

Exemplary embodiments of a discharge light-emitting device according to the present invention will be described in detail below with reference to the accompanying drawings. Same or similar numbers are assigned to the same or similar portions in the drawings. However, the drawings are only schematic, and relations between thickness and plane dimension, the ratio of the thickness in each layer, and the like, may differ from actual objects. Therefore, the specific thickness and the dimension must be estimated according to the following descriptions. Further, the dimensional relations and the thickness may differ among the drawings.

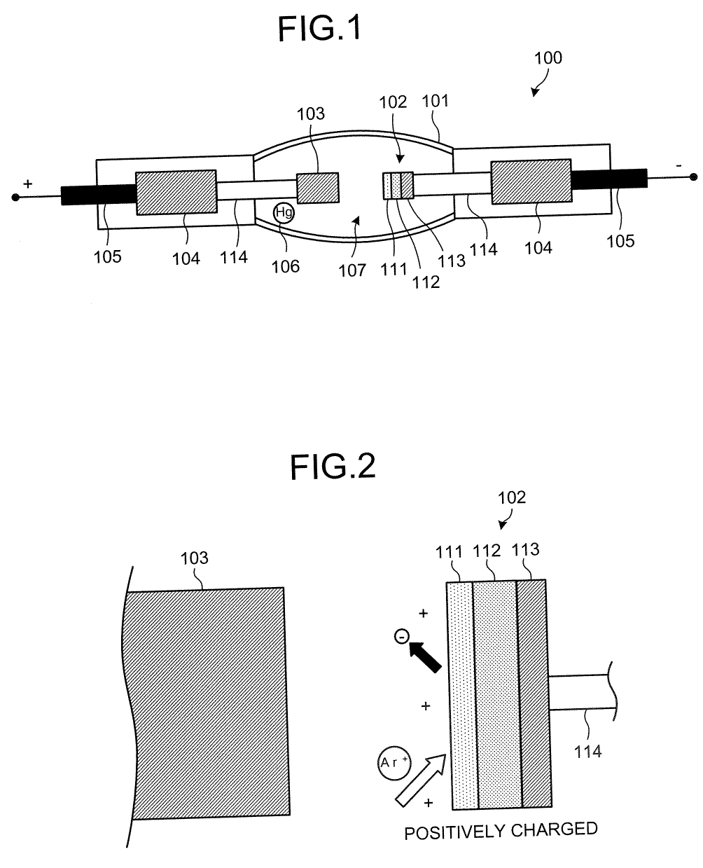

FIG. 1 is a cross-sectional drawing schematically showing a configuration of a discharge light-emitting device 100 according to a first embodiment. As shown in FIG. 1, the discharge light-emitting device 100 according to the first embodiment includes an outer envelope 101, discharge gas 107 that is contained in the outer envelope 101, an anode 103 and a cathode 102 that are provided in the outer envelope 101, electrode members 114 that are connected, respectively, to the anode 103 and the cathode 102, molybdenum foils 104 that are connected respectively to the electrode members 114, and leads 105 that are connected respectively to the molybdenum foils 104. The leads 105 are each connected to a power supply, which is not shown in the drawings.

Material forming the outer envelope 101 is not specifically limited as long as the outer envelope 101 can house the anode 103 and the cathode 102 inside, contain the discharge gas 107, and transmit light; however, the outer envelope 101 is preferably made by material that has a high melting point equal to 1000° C. or higher. This is because it is necessary to evaporate mercury 106 inside the outer envelope 101 when a trace of the mercury 106 is included in the discharge gas 107. Since the evaporation of the mercury 106 takes place when the outer envelope 101 is placed under high temperature environment (for example, 1000° C.), the material forming the outer envelope 101 should have the high melting point. In the present embodiment, a quartz tube having a hollow sealed configuration and transparency is used for the outer envelope 101.

The discharge gas 107 is mixture gas made by inert gas containing a trace of the mercury 106, for example. The mercury 106 contained in the inert gas allows mercury light emission and also serves as a load resistor for developing a lamp voltage. Detailed description of the load resistor for developing a lamp voltage will be presented in the following. Steam pressure of the mercury 106 inside the outer envelope 101 is increased with temperature increase when arc discharge occurs due to applied high voltage pulses between the anode 103 and the cathode 102. Consequently, the lamp voltage is increased, and lamp electric power and light intensity of the discharge light-emitting device 100 are increased. As the lamp electric power reaches a predetermined value, the light intensity stabilizes.

The inert gas described above is, for example, helium gas (He), neon gas (Ne), argon gas (Ar), krypton gas (Kr), xenon gas (Xe), radon gas (Rn), and the like. Argon as containing a trace of halogen gas is used in the present embodiment. The argon gas is used to improve the starting condition of the discharge, and the halogen gas is used to suppress lamp blackening and loss of transparency.

Material forming the anode 103 is not limited as long as the material is electrically conductive metal, and tungsten is used in the present embodiment. The discharge starts between the cathode 102 and the anode 103 inside the outer envelope 101 when the high voltage pulses applied to the anode 103 and later-described cathode 102 breaks insulation between the cathode 102 and the anode 103. Further, the shape of the anode 103 is not limited, and the shapes such as rod-like, sheet-like, circle-like, coil-like, and comb-like shapes may be used.

The cathode 102 is configured by an electrically conductive substrate 113, an n-type semiconductor layer 112 that is provided on the electrically conductive substrate 113, and a p-type semiconductor layer 111 that is provided on the n-type semiconductor layer 112, and a pn junction is formed by the n-type semiconductor layer 112 and the p-type semiconductor layer 111. Further, the cathode 102 is arranged opposite to the anode 103 with a discharge space of the discharge gas 107 therebetween. Furthermore, the cathode 102, on being forward-biased, emits electrons from the p-type semiconductor layer 111. The mechanism of the emission of electrons will be described later.

The discharge space mentioned above is a space inside the outer envelope 101 in which the discharge takes place due to the application of high voltage pulses between the cathode 102 and the anode 103.

Material forming the electrically conductive substrate 113 is not limited as long as the material is electrically conductive metal, and the material is preferably the metal having a high melting point equal to or higher than 1000° C. This is because the n-type semiconductor layer 112 and the p-type semiconductor layer 111 are formed on the electrically conductive substrate 113 mostly under high temperature environment (for example, 800° C.), and the metal having the high melting point prevents melting and deformation of the electrically conductive substrate 113 at the formation of the n-type semiconductor layer 112 and the p-type semiconductor layer 111. Molybdenum, tungsten, or the like is used as the metal having the melting point equal to or higher than 1000° C. as described above. In the present embodiment, molybdenum is used for the electrically conductive substrate 113.

Further, a shape of the electrically conductive substrate 113 is not limited as long as the n-type semiconductor layer 112 and the p-type semiconductor layer 111 are formable thereon, thus a shape such as a cylindrical shape can be used.

The n-type semiconductor layer 112 is provided on the surface of the electrically conductive substrate 113. Material forming the n-type semiconductor layer 112 is not particularly limited as long as the material has n-type electrical conductivity, and the p-type semiconductor layer 111 that will be described later is formable thereon. N-type diamond layer doped with phosphorous (P), which is used as impurity, is used as the n-type semiconductor layer 112 of the present embodiment.

The p-type semiconductor layer 111 is provided on the surface of the n-type semiconductor layer 112, and the p-type semiconductor layer 111 is preferably formed by wide-gap semiconductor having small positive or negative electron affinity. Diamond is preferably used. P-type diamond layer doped with boron (B) as impurity is used as the p-type semiconductor layer 111 of the present embodiment. The p-type diamond layer employed as the p-type semiconductor layer 111 has a property of emitting electrons from its surface when forward-biased.

FIG. 2 is a cross-sectional view schematically showing a state between the cathode 102 and the anode 103 after the discharge starts. As shown in FIG. 2, the discharge occurs due to insulation breakdown between the cathode 102 and the anode 103; the insulation breakdown is caused by the application of positive high voltage pulses between the anode 103 and the cathode 102 from the power supply not shown in the drawing. Then, secondary electron emission occurs since ionized positively charged argon ions that are produced by the discharge collide with the p-type semiconductor layer 111. Consequently, the surface of the p-type semiconductor layer 111 is positively charged. Then, positive charges are accumulated on the surface of the p-type semiconductor layer 111 every time the secondary electron emission takes place, and the accumulated positive charges increases the voltage between the p-type semiconductor layer 111 and the n-type semiconductor layer 112.

The diffusion potential between the p-type diamond layer and the n-type diamond layer is generally approximately 5 eV when the p-type diamond layer is used as the p-type semiconductor layer 111 and the n-type diamond layer is used as the n-type semiconductor layer 112. Therefore, current flows between the p-type semiconductor layer 111 and the n-type semiconductor layer 112 when the voltage equal to or more than 5 V is applied.

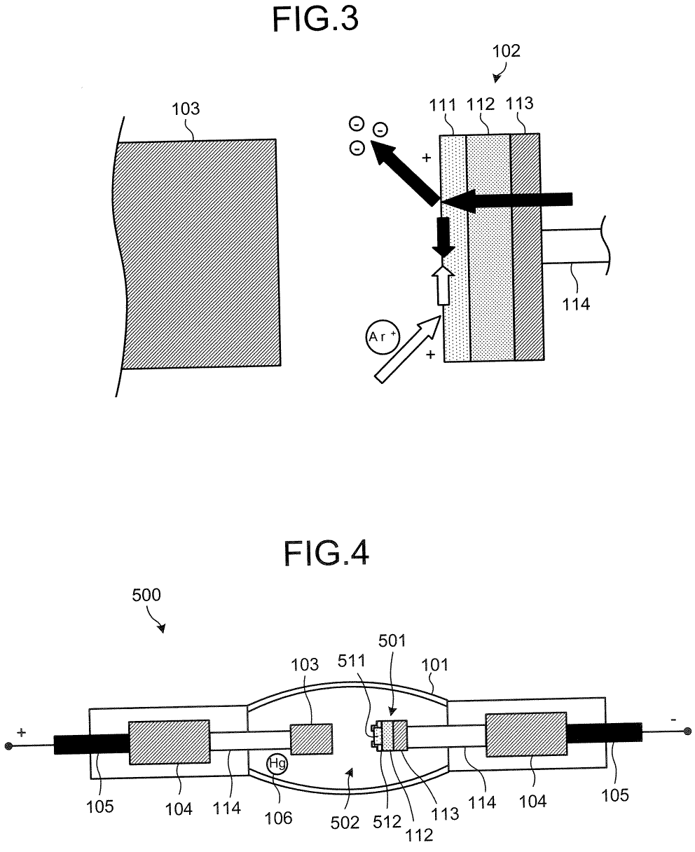

FIG. 3 is a cross-sectional view schematically showing a state between the cathode 102 and the anode 103 after a certain time-interval lapses from the start of the discharge. As shown in FIG. 3, the pn junction formed by the p-type semiconductor layer 111 and the n-type semiconductor layer 112 is forward-biased due to the accumulated positive charges on the surface of the p-type semiconductor layer 111. Then, current flows over the pn junction in the forward direction when a predetermined voltage is applied to the forward-biased pn junction.

Further, the n-type semiconductor layer 112 is preferably doped with impurity with higher concentration compared with that in the p-type semiconductor layer 111, in order to increase the forward current described above. The forward current can be increased by supplying more electrons from the n-type semiconductor layer 112 to the p-type semiconductor layer 111. In the cathode 102 of the present embodiment, the concentration of the doped impurity in the n-type diamond layer is higher than that in the p-type diamond layer. Consequently, more electrons are injected from the n-type semiconductor layer 112 to the p-type semiconductor layer 111 in the cathode 102 according to the present embodiment.

The electrons injected into the p-type semiconductor layer 111 reach the surface of the p-type semiconductor layer 111 by diffusion. A portion of the electrons reaching the surface neutralizes the positive charges accumulated on the surface, and the rest of the electrons are emitted to the discharge space from the surface of the p-type semiconductor layer 111.

The p-type semiconductor layer 111 is preferably formed by the wide-gap semiconductor having small positive or negative electron affinity so as to emit the electrons to the discharge space from the surface of the p-type semiconductor layer 111. Having small electron affinity means vacuum level exists at a position lower than the bottom of the conducting band of the p-type semiconductor layer 111. In other words, when the electric affinity is low, the electrons injected into the conducting band of the p-type semiconductor layer 111 from the n-type semiconductor layer 112 are easily emitted to the discharge space since the electrons are not obstructed by a barrier between the surface of the p-type semiconductor layer 111 and the discharge space. Further, the injected electrons are easily emitted to the discharge space since the barrier between the surface of the p-type semiconductor layer 111 and the discharge space is small.

P-type diamond, which is the wide-gap semiconductor as described in the present embodiment, is preferably used as the material having the small electron affinity to form the p-type semiconductor layer 111. Consequently, the electrons are easily emitted to the discharge space as described above.

Then, it is required to apply the forward bias voltage between the p-type semiconductor layer 111 and the n-type semiconductor layer 112 for the emission of electrons from the p-type semiconductor layer 111. In other words, it is required to apply positive voltage to the surface of the p-type semiconductor layer 111, which is an electron emissive surface.

Electrodes may directly be connected to the p-type semiconductor layer 111 in order to apply the forward bias voltage; however, high electron emission efficiency cannot be obtained since the electrodes that are connected directly to the p-type semiconductor layer 111 function as a barrier when the electrons are emitted from the p-type semiconductor layer 111 to the discharge space. Hence, it is required to apply the forward bias voltage without connecting the electrodes to the p-type semiconductor layer 111.

In the present embodiment, the application of positive high-voltage pulses between the anode 103 and the cathode 102 generates the positively charged argon ions, which then collide with the p-type semiconductor layer 111 to cause the secondary electron emission, whereby the surface of the p-type semiconductor layer 111 is positively charged.

Thus, in the present embodiment, it is possible to forward-bias the p-type semiconductor layer 111 without using the electrodes. Then, current flows in the cathode 102 of the present embodiment when a predetermined voltage (equal to or more than 5 volts when the p-type semiconductor layer 111 and the n-type semiconductor layer 112 are formed by diamond) is applied between the p-type semiconductor layer 111 and the n-type semiconductor layer 112, due to the positive charges located on the surface of the p-type semiconductor layer 111. Thus, the electrons are injected from the n-type semiconductor layer 112 to the p-type semiconductor layer 111. This state moves to an equilibrium state where the positive electric charges on the surface of the p-type semiconductor layer 111 caused by the incoming positive ions are neutralized with some electrons injected into the p-type semiconductor layer 111 and reaching the surface. Thus, the discharge is maintained.

Since the p-type semiconductor layer 111 of the discharge light-emitting device 100 according to the present embodiment are not directly connected to an electrode, there is no barrier when the injected electrons are discharged into the discharge space. Further, there are no factors which lower the voltage of the surface of the p-type semiconductor layer 111. Therefore, the injected electrons are easily discharged into the discharge space, and the discharge light-emitting device 100 of the present embodiment can obtain high electron emission efficiency.

Further, luminous efficiency is improved due to the decrease in discharge starting voltage and discharge maintaining voltage. Such decrease is caused by the high electron emission efficiency of the p-type semiconductor layer 111, since electric power required for the light emission can be reduced.

Further, in the discharge light-emitting device 100 according to the present embodiment, large discharge current can flow at a lower temperature compared to the temperature in the conventional discharge light-emitting device. In other words, life span of the discharge light-emitting device 100 becomes longer than the conventional discharge light-emitting device since the discharge light-emitting device 100 can be functioned under static environment of low temperature.

Next, one example of production process of the cathode 102 of the present embodiment will be described. First, a molybdenum rod is prepared as the electrically conductive substrate 113, and the n-type diamond layer having a thickness of approximately 5 μm is formed at one end portion of the molybdenum rod as the n-type semiconductor layer 112. Although any methods may be employed for the formation of the n-type diamond layer, microwave plasma Chemical Vapor Deposition (CVD) is employed in the present embodiment. In the microwave plasma CVD, microwave power is set to 1.5 kW, hydrogen flux is set to 200 sccm, methane gas flux is set to 4 sccm, methane concentration of material gas is set to 2%, and pressure of the material gas is set to 80 Torr. Then the molybdenum rod is heated to 8500C. Further, the phosphorus (P) is used as dopant of the n-type semiconductor layer 112 and PH₃ gas is supplied to grow the diamond layer. Thus, the n-type diamond layer 112 is formed on the electrically conductive substrate 113.

The diamond layer doped with phosphorous (P) is used as the n-type semiconductor layer 112, as described above in the present embodiment. In general, large current does not flow in the phosphorous-doped diamond at room temperature since it has high resistance. However, in the present embodiment, large current can flow in the phosphorous-doped diamond layer when the high-voltage pulses are applied to the cathode 102 and the anode 103 to generate flows of discharge current thereby heating-up the n-type diamond layer. Thus, with the application of the high-voltage pulses, the temperature of the n-type diamond layer rises to cause gradual decrease in resistance, in other words, the n-type diamond layer gradually changes its property so as to allow flow of large electric current therethrough. Thus, the large electric current can flow through the diamond layer even when the diamond layer is doped with phosphorous.

After forming the n-type semiconductor layer 112 on the electrically conductive substrate 113, the p-type diamond layer having a thickness of approximately 1 μm is formed as the p-type semiconductor layer 111. The p-type diamond layer is formed, for example, by microwave plasma CVD. The microwave plasma CVD, here, uses boron (B) as p-type dopant and B₂H₆ gas is supplied to grow the diamond layer. Other conditions are the same as the conditions given above concerning the formation of the n-type diamond layer.

In the above description of the present embodiment, the discharge light-emitting device 100 is configured from the electrically conductive substrate 113, the n-type semiconductor layer 112 provided on the electrically conductive substrate 113, and the p-type semiconductor layer 111 provided on the n-type semiconductor layer 112, and the cathode 102 has the pn junction formed by the n-type semiconductor layer 112 and the p-type semiconductor layer 111. The discharge light-emitting device 100 can be used as a high-pressure gas discharge lamp such as an HID lamp.

The present embodiment is not limited to the high-pressure discharge light-emitting device, and can be used for any kinds of discharge light-emitting devices. For example, the discharge light-emitting device including the cathode described above can be used as a low-pressure hot cathode lamp.

The discharge light-emitting device 100 according to the present embodiment described above has the pn junction formed by the n-type semiconductor layer 112 and the p-type semiconductor layer 111, and the pn junction can be forward-biased since the positive charges are accumulated on the surface of the p-type semiconductor layer 111 due to the discharge. Further, the surface of the p-type semiconductor layer 111 does not have the barrier of the discharge such as a coated structure against the voltage application, thus large amount of the electron emission current can flow from the p-type semiconductor layer 111. Furthermore, higher chemical stability and large sputtering endurance can be obtained when the diamond is used as the material of the p-type semiconductor layer 111 that emits the electrons. Consequently, the discharge lamp light source with high discharge efficiency and long life span is realized.

FIG. 4 is a cross-sectional view schematically showing a configuration of a discharge light-emitting device 500 according to a second embodiment. In the present embodiment, configurations are the same as those in the first embodiment except that this embodiment includes a cathode 501 that is different from the cathode 102 and a discharge gas 502 that is different from the discharge gas 107. Therefore, the description of the configurations already explained in the first embodiment above will not be repeated.

The discharge gas 502 contains argon gas (Ar) and a trace of halogen gas similar to those in the first embodiment above, and the discharge gas 502 further contains a trace of hydrogen. The reason for containing the hydrogen will be explained later.

The cathode 501 is configured by the electrically conductive substrate 113, the n-type semiconductor layer 112 that is provided on the electrically conductive substrate 113, a p-type semiconductor layer 511 that is provided on a top of the n-type semiconductor layer 112, and an insulating layer 512 that covers the junction of the p-type semiconductor layer 511 and the n-type semiconductor layer 112; and the n-type semiconductor layer 112 and the p-type semiconductor layer 511 form a pn junction. Further, the surface of the p-type semiconductor layer 511 is hydrogen-terminated.

The p-type semiconductor layer 511 differs from the p-type semiconductor layer 111 according to the first embodiment since the p-type semiconductor layer 511 has a different shape and has hydrogen termination. The shape of the p-type semiconductor layer 511 differs from the shape of the p-type semiconductor layer 111 since the insulating layer 512 covers the junction of the p-type semiconductor layer 511 and the n-type semiconductor layer 112. In other words, the p-type semiconductor layer 511 can have any shapes as long as the junction is covered by the insulating layer 512.

The insulating layer 512 covers the junction of the p-type semiconductor layer 511 and the n-type semiconductor layer 112, and thus protects short-circuit of the pn junction of the hydrogen-terminated p-type semiconductor layer 511 and the n-type semiconductor layer 112. Further, the insulating layer 512 is preferably formed by insulating material, and SiO₂ is used for the insulating layer 512 in the present embodiment.

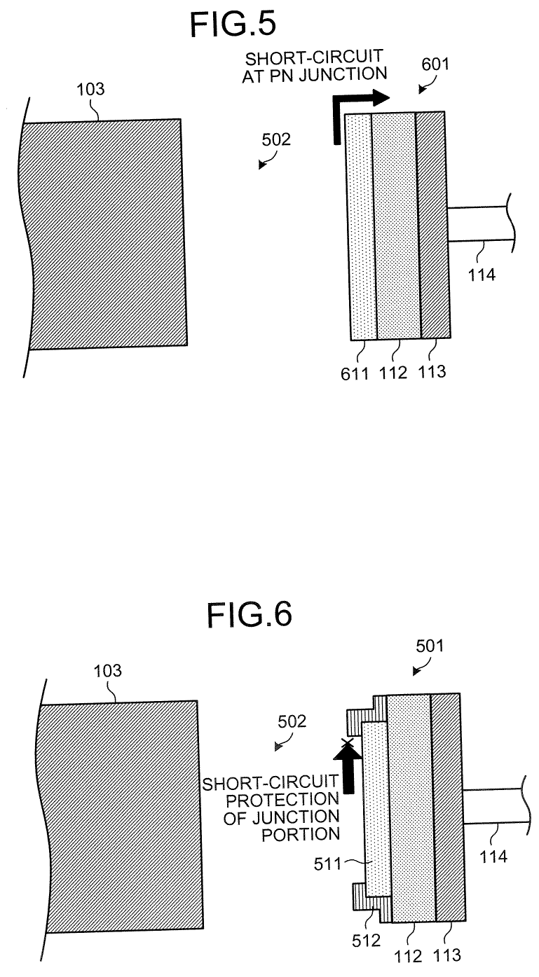

FIG. 5 is a cross-sectional view schematically showing the anode 103 and a cathode 601 according to an embodiment different from the present embodiment to explain the discharge light-emitting device 500 of the second embodiment. The cathode 601 includes the electrically conductive substrate 113, the n-type semiconductor layer 112 that is provided on the electrically conductive substrate 113, and a p-type semiconductor layer 611 that is provided on the n-type semiconductor layer 112, and the surface of the p-type semiconductor layer 611 is hydrogen-terminated. The hydrogen-termination of the surface of the p-type semiconductor layer 611 causes the electron affinity to decrease, thereby resulting in the negative electron affinity of the surface of the p-type semiconductor layer 611.

In the embodiment shown in FIG. 5, the outer envelope 101 (not shown) is filled with the discharge gas 502 containing a trace of hydrogen. Thus, the hydrogen termination occurs and is maintained at the surface of the p-type semiconductor layer 611 due to discharge plasma caused by applied high-voltage pulses, and the electron emission property of the cathode 601 further improves. However, a thin surface conducting layer having high electric conductivity is formed when a diamond surface is hydrogen-terminated. The surface conducting layer is also formed at the pn junction that is exposed to the discharge space. Then, a leakage path shown by an arrow in the drawing is generated by the surface conducting layer, and the forward-biased voltage cannot be applied due to the short-circuit of the pn junction. Therefore, it is required to prevent the formation of the surface conducting layer at the pn junction.

FIG. 6 is a cross-sectional view schematically showing the anode 103, the discharge gas 502, and the cathode 501, according to the present embodiment. The surface of the p-type semiconductor layer 511 of the cathode 501 shown in FIG. 6 is hydrogen-terminated. The insulating layer 512 covers the junction of the n-type semiconductor layer 112 and the p-type semiconductor layer 511, and thus preventing the formation of hydrogen termination at the junction, i.e., preventing the formation of the surface conducting layer having high electric conductivity at the junction of the n-type semiconductor layer 112 and the p-type semiconductor layer 511.

The hydrogen termination occurs on the surface of the p-type semiconductor layer 511 since the p-type semiconductor layer 511 is exposed to hydrogen plasma, when the discharge is caused in the hydrogen-containing discharge gas 502. However, the hydrogen termination does not occur at the junction since the junction is covered by the insulating layer 512. Therefore, the short-circuit of the pn junction can be protected, and the electron emission property can be further improved.

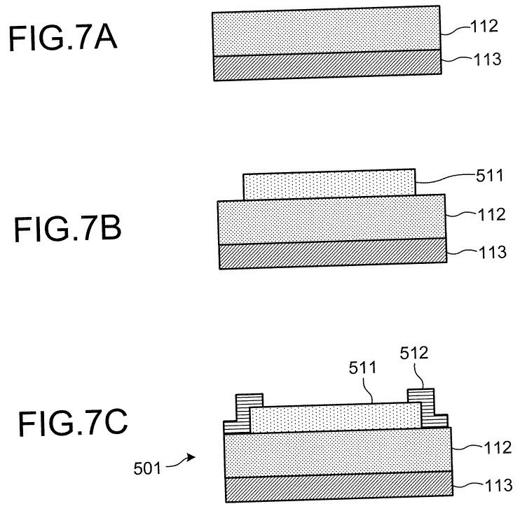

FIGS. 7A to 7C are schematic diagrams showing a production process of the cathode 501 provided in the discharge light-emitting device 500 according to the present embodiment.

First, the n-type semiconductor layer 112 is formed on the electrically conductive substrate 113 that is formed from molybdenum material, for example, as shown in FIG. 7A. More precisely, an n-type diamond layer being 5 μm in thickness is formed at one end surface of the rod-like base by the CVD, for example.

Next, the p-type semiconductor layer 511, such as a p-type polycrystalline diamond layer having a thickness of 1 μm is formed on the n-type diamond layer by the CVD as shown in FIG. 7B, and the end portion of the formed p-type polycrystalline diamond layer is etched by reactive ion etching (RIE) in which O₂ gas is used as the etching gas. Consequently, the p-type semiconductor layer 511 in which the end portion is removed, is formed. Here, the impurity to be doped is boron (B), similarly to the p-type diamond layer 111 of the first embodiment.

Then, the reactive ion etched (RIE) end portion of the p-type semiconductor layer 511 which is the junction of the n-type semiconductor layer 112 and the p-type semiconductor layer 511 is covered by the insulating layer 512 as shown in FIG. 7C. In order to cover the junction by the insulating layer 512, the SiO₂ layer is formed by the CVD, for example. Then, the insulating layer 512 is formed by etch-removing the SiO₂ layer except for the end portion of the p-type semiconductor layer 511 which is reactive ion etched (RIE). Consequently, the cathode 501 is produced.

The discharge light-emitting device 500 according to this embodiment allows the surface of the p-type semiconductor layer 511 to be hydrogen-terminated by a trace of hydrogen contained in the discharge gas 502, and the short-circuit occurring at the pn junction is protected by the insulating portion exposed to the discharge space at the pn junction. Consequently, the hydrogen-terminated surface of the p-type semiconductor layer 511 provided with the negative electron affinity can be used as the electron emissive surface, and the discharge light-emitting device 500 can possess higher electric-emitting efficiency since the barrier becomes smaller when the electrons are emitted to the discharge space from the p-type semiconductor layer 511.

The cathodes used in the discharge light-emitting devices according to the first and the second embodiments described above are limited to the application with direct current since the cathode only emits electrons and cannot receive the electrons. A discharge light-emitting device that can be used for alternate current will be explained in a third embodiment.

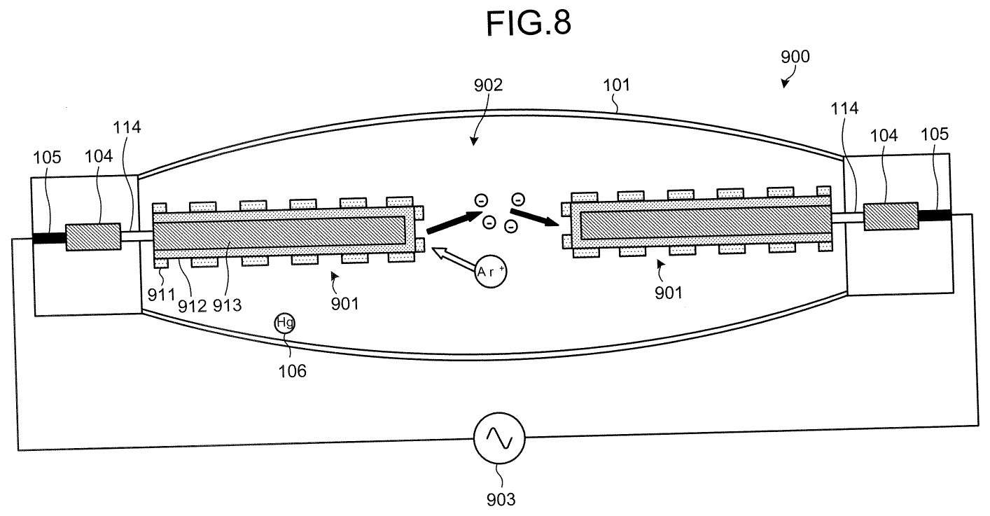

FIG. 8 is a cross-sectional view schematically showing a configuration of a discharge light-emitting device 900 according to the third embodiment. The present embodiment differs from the discharge light-emitting device 100 according to the first embodiment described above only in the configuration of the anode 103 and the cathode 102, and the anode 103 and the cathode 102 is replaced by a pair of electrodes 901 in the discharge light-emitting device 900. Other configurations are similar to those in the first embodiment, thus the description thereof will not be repeated. Here, each lead 105 is connected to an alternate current power supply 903.

The electrode 901 includes an electrically conductive substrate 913, an n-type semiconductor layer 912 that is provided on the electrically conductive substrate 913, and a p-type semiconductor layer 911 that is provided on the n-type semiconductor layer 912 so as to expose a portion of the n-type semiconductor layer 912, and a pn junction is formed by the n-type semiconductor layer 912 and the p-type semiconductor layer 911.

Similarly to the first embodiment, the electrically conductive substrate 913 can be formed by any metals as long as the metal is electrically conductive, and is preferably configured by the metal having a high melting point equal to or higher than 1000° C. The electrically conductive substrate 913 according to the present embodiment is formed from molybdenum, and has a rod-like shape.

The n-type semiconductor layer 912 is provided on the surface of the electrically conductive substrate 913. The n-type semiconductor layer 912 has the n-type electric conductivity similarly to the first embodiment, and its material is not limited as long as the p-type semiconductor layer 911 that will be described later is formable on the n-type semiconductor layer 912. The n-type diamond layer doped with phosphorous (P) as impurity is used as the n-type semiconductor layer 912 of the present embodiment. The n-type semiconductor layer 912, for example, is formed on all the surfaces of the electrically conductive substrate 913 except on the surface where the electrically conductive substrate 913 is connected to the electrode member 114.

The p-type semiconductor layer 911 is provided on the surface of the n-type semiconductor layer 912 so as to expose a portion of the n-type semiconductor layer 912 to the discharge gas 902. In other words, the electrode 901 includes a portion in which the p-type semiconductor layer 911 is exposed, and a portion in which the n-type semiconductor layer 912 is exposed. Further, the p-type semiconductor layer 911 is preferably formed by wide-gap semiconductor that has small positive or negative electron affinity, similarly to the first embodiment. Diamond is preferably used among the wide-gap semiconductor mentioned above. The p-type semiconductor layer 911 according to the present embodiment is the p-type diamond layer doped with boron (B) as impurity, and the p-type diamond layer emits electrons from its surface when forward-biased. Consequently, long life span of the discharge light-emitting device 900 can be realized when diamond is used for each of the p-type semiconductor layer 911 and the n-type semiconductor layer 912, since the use of diamond results in excellent chemical stability and large sputtering endurance.

Only the p-type semiconductor layer is exposed on the surface of the cathode used in the first and the second embodiments described above. Then, current does not flow when the cathode is used as an anode, since connected opposite-direction diodes configures the anode. In other words, the cathode in which only the p-type semiconductor layer is exposed does not work as the anode that receives the electrons.

In the electrode 901 of the discharge light-emitting device 900 of the present embodiment, not only the p-type semiconductor layer 911 but also the n-type semiconductor layer 912 is exposed to the discharge space.

In other words, the exposed portion of the n-type semiconductor layer 912 can receive electrons since the opposite-directionally connected diodes do not configure the cathode, and the cathode functions as the anode.

The electrode 901 having exposed portion of the n-type semiconductor layer 912 as described above can emit electrons like an ordinary cathode, and it can receive electrons like an ordinary anode.

The discharge light-emitting device 900 according to the present embodiment is provided with the pair of the electrodes 901 located opposite to each other in the outer envelope 101, as shown in FIG. 8. The left-side electrode 901 works as the cathode, and emits electrons by the secondary electron emission caused by incident of positive ions (argon ion). On the other hand, the right-side electrode 901 works as the anode, and receives electrons from the discharge space.

The left-side electrode 901 is forward-biased between the p-type semiconductor layer 911 and the n-type semiconductor layer 912 due to the incident positive ions (argon ion) produced by the discharge. Then, electrons are injected from the n-type semiconductor layer 912 to the p-type semiconductor layer 911 when a predetermined voltage (equal to or higher than 5 volts when the p-type semiconductor layer 911 and the n-type semiconductor layer 912 are both configured by diamond) is applied between the p-type semiconductor layer 911 and the n-type semiconductor layer 912. This state moves to an equilibrium state where the positive electric charges on the surface of the p-type semiconductor layer 911 caused by the incoming positive ions are neutralized with some electrons injected into the p-type semiconductor layer 911 and reaching the surface. Thus, the discharge to the discharge space is maintained.

Further, the discharge to the discharge space occurs when the right-side electrode 901 works as the cathode and the left-side electrode 901 works as the anode due to the reversed polarity of an alternate current signal of the alternate current power supply 903. In other words, the discharge light-emitting device 900 according to the present embodiment can be driven by the alternate current signal.

Further, the discharge light-emitting device 900 according to the present embodiment allows the emission of the electrons to the discharge space similarly to the hot cathode lamp, even though the heating by the heating filament is not performed, since the discharge light-emitting device 900 is provided with enough energy to emit the electrons from the p-type semiconductor layer 911 to the discharge space. In other words, the discharge light-emitting device 900 does not require the heating filament, thus it can be processed into thin cylinder and able to emit the electrons at a low temperature. Consequently, the discharge light-emitting device 900 can reduce influences on the other equipment, compared to the case when a conventional hot cathode lamp is used. Therefore, the discharge light-emitting device 900 can be used as a backlight.

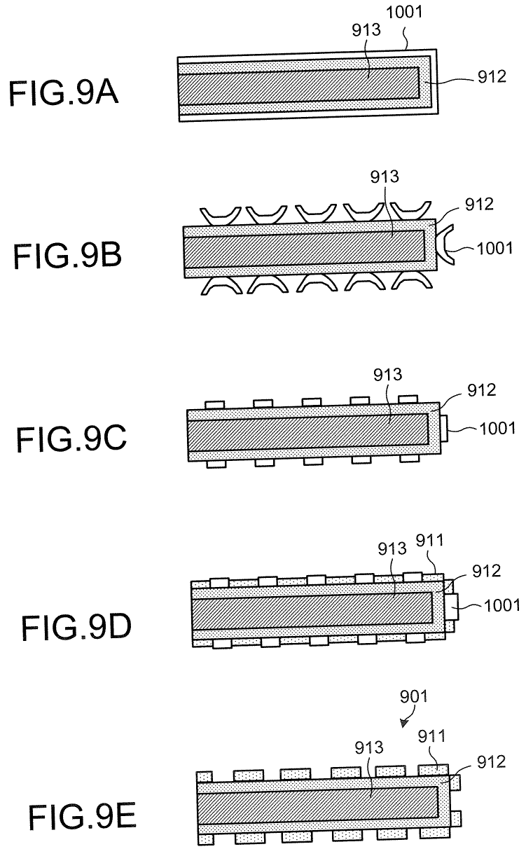

FIGS. 9A to 9E are schematic diagrams showing a production process of the electrode 901 of the discharge light-emitting device 900 according to the present embodiment.

As shown in FIG. 9A, a molybdenum rod used as the electric-conducting substrate 913 is prepared first. A 5 μm-thick n-type polycrystalline diamond layer, which is used as the n-type semiconductor layer 912, is formed on all of the surfaces of the molybdenum rod except the end portion to which the electrode member 114 is connected. The microwave plasma CVD may be used for forming the n-type diamond layer. Then, a molybdenum layer 1001 is formed on the n-type semiconductor layer 912.

Next, the electrically conductive substrate 913, and the n-type semiconductor layer 912 and the molybdenum layer 1001 formed thereon are heated with the temperature of, for example, 600° C.

Then, a portion of the molybdenum layer 1001 is separated from the n-type semiconductor layer 912 as shown in FIG. 9B because molybdenum has larger heat expansion coefficient than a semiconductor.

The separated portion of the molybdenum layer 1001 is etched by aqueous solution of HNO₃ and H₂SO₄, as shown in FIG. 9C.

Next, an approximately 1 μm-thick p-type polycrystalline diamond layer used as the p-type semiconductor layer 911 is formed on the exposed portion of the n-type semiconductor layer 912 that is not covered by the molybdenum layer 1001, as shown in FIG. 9D. The microwave plasma CVD is used, for example. The p-type polycrystalline diamond is formed only on the exposed portion of the n-type semiconductor layer 912 and not on the molybdenum layer 1001 because diamond grows more on diamond than on molybdenum.

Then, the unnecessary molybdenum layer 1001 is removed by etching, as shown in FIG. 9E. Consequently, the p-type semiconductor layer 911 is formed on the n-type semiconductor layer 912 with a portion of the p-type semiconductor layer 911 being exposed.

As described above, not only the p-type diamond layer 911 but also a portion of the n-type diamond layer 912 are exposed to the discharge space in the electrode 901 of the discharge light-emitting device 900 according to the present embodiment. Then, the electrodes 901 configured as described above are located opposite to each other. Consequently, the anode side and the cathode side have the same configuration, and the discharge light-emitting device 900 can be driven by an alternating current signal. Therefore, the discharge light-emitting device 900 having high efficiency and long life span, being able to be driven by the alternating current signal, is realized.

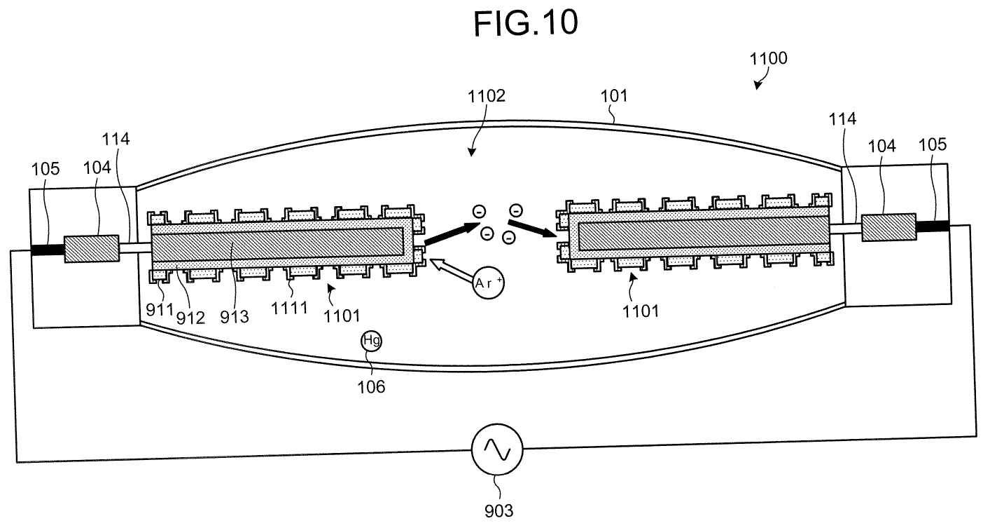

FIG. 10 is a cross-sectional view schematically showing a configuration of a discharge light-emitting device 1100 according to a fourth embodiment. The present embodiment differs from the third embodiment described above only in the configuration of the electrode 901 and the material forming the discharge gas 902, and the electrode and the discharge gas of the third embodiment is replaced by an electrode 1101 and discharge gas 1102, respectively. Descriptions for other configurations will not be repeated since the configurations are similar to those in the first embodiment.

The discharge gas 1102 contains argon (Ar), a hint of halogen, and a hint of hydrogen, similarly to the discharge gas 502 according to the second embodiment.

The electrode 1101 is configured by the electrically conductive substrate 913, the n-type semiconductor layer 912 that is provided on the electrically conductive substrate 913, the p-type semiconductor layer 911 that is provided on the n-type semiconductor layer 912 so as to expose a portion of the n-type semiconductor layer 912, and an insulating layer 1111 that covers the junction of the p-type semiconductor layer 911 and the n-type semiconductor layer 912, and a pn junction is formed by the n-type semiconductor layer 912 and the p-type semiconductor layer 911. The surface of the p-type semiconductor layer 911 is hydrogen-terminated in the electrode 1101.

The insulating layer 1111 covers the junction of the p-type semiconductor layer 911 and the n-type semiconductor layer 912, and thus protects short-circuit of the junction of the hydrogen-terminated p-type semiconductor layer 911 and the n-type semiconductor layer 912. Further, SiO₂ is used to form the insulating layer 1111 similarly to the second embodiment.

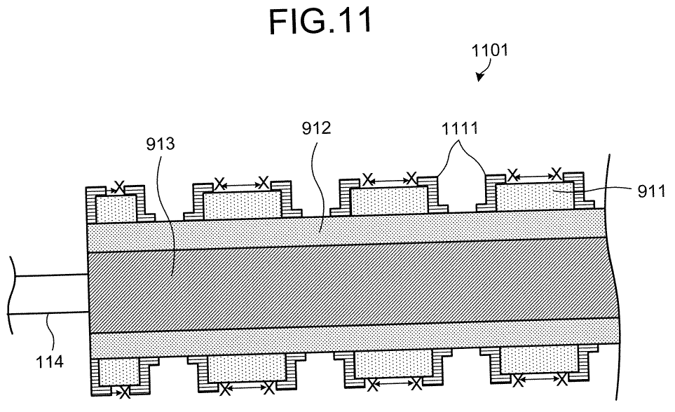

FIG. 11 is a cross-sectional view schematically showing the electrically conductive substrate 913, the n-type semiconductor layer 912, the p-type semiconductor layer 911, and the insulating layer 1111, according to the present embodiment. As shown in FIG. 11, the junction of the n-type semiconductor layer 912 and the p-type semiconductor layer 911 is covered by the insulating layer 1111. Consequently, the occurrence of the hydrogen termination at the junction is prevented, thus the generation of the surface conducting layer having high electric conductivity is prevented.

Then, the hydrogen termination occurs on the surface of the p-type semiconductor layer 911 when the discharge is caused in the hydrogen-containing discharge gas 1102 since the electrode 1101 is exposed to hydrogen plasma. Further, the insulating layer 1111 prevents the hydrogen termination at the junction of the n-type semiconductor layer 912 and the p-type semiconductor layer 911. In other words, electron emission property can be further improved due to the hydrogen-terminated surface of the p-type semiconductor layer 911, and at the same time, short-circuit at the junction of the n-type semiconductor layer 912 and the p-type semiconductor layer 911 can be prevented.

The exposed portion to the discharge space at the junction of the n-type semiconductor layer 912 and the p-type semiconductor layer 911 is insulated in the discharge light-emitting device 1100 according to the present embodiment. Consequently, the electrode 1101 of the discharge light-emitting device 1100 can prevent the formation of short-circuit by the hydrogen termination at the pn junction. Further, the electrode 1101 of the discharge light-emitting device 1100 can hydrogen-terminate the p-type semiconductor layer 911 by a trace of hydrogen contained in the discharge gas 1102. Consequently, the electrode 1101 is provided with the hydrogen-terminated p-type semiconductor layer 911 having negative electron affinity as the electron emissive surface. Further, the electrode 1101 works as cathode and anode. Consequently, the similar effect to the discharge light-emitting device 900 of the third embodiment described above can be obtained, and the discharge efficiency is further improved.

The discharge light-emitting devices according to the first to the fourth embodiments can be applied to a discharge light-emitting device using high-pressure gas or low-pressure gas, and the pressure of the discharge gas contained in the outer envelope is not particularly limited.

Thus, the discharge light-emitting device according to the present invention is particularly suitable for the usage demanding long life span and low electricity consumption while using the discharge light-emitting device, such as HID lamp or backlight of liquid crystal display.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A discharge light-emitting device comprising:
an outer envelope filled with discharge gas; and
a pair of electrodes provided in the outer envelope, at least one of the electrodes including
an electrically conductive substrate,
an n-type semiconductor layer provided on the substrate, and
a p-type diamond layer provided on the n-type semiconductor layer.

2. The device according to claim 1, wherein
the n-type semiconductor layer is doped with a higher concentration of impurity compared to a concentration of impurity in the p-type diamond layer.

3. The device according to claim 1, wherein
the n-type semiconductor layer is an n-type diamond layer.

4. The device according to claim 1, wherein
the discharge gas is formed by mixture gas containing inert gas and halogen gas.

5. The device according to claim 1 further comprising
an insulating layer that covers a junction of the p-type diamond layer and the n-type semiconductor layer.

6. The device according to claim 1, wherein
the discharge gas is formed by mixture gas containing hydrogen.

7. The device according to claim 1, wherein
a surface of the p-type diamond layer is hydrogen-terminated.

8. A discharge light-emitting device comprising:
an outer envelope filled with discharge gas; and
a pair of electrodes including
an electrically conductive substrate,
an n-type semiconductor layer provided on the substrate, and
a p-type diamond layer provided on the n-type semiconductor layer so as to expose a portion of the n-type semiconductor layer.

9. The device according to claim 8, wherein
the n-type semiconductor layer is doped with a higher concentration of impurity compared to a concentration of impurity in the p-type diamond layer.

10. The device according to claim 8, wherein
the p-type wide-gap semiconductor layer is a p-type diamond layer.

11. The device according to claim 8, wherein
the discharge gas is formed by mixture gas containing inert gas and halogen gas.

12. The device according to claim 8 further comprising:
an insulating layer that covers a junction of the p-type diamond layer and the n-type semiconductor layer.

13. The device according to claim 12, wherein
the discharge gas is formed by mixture gas containing hydrogen.

14. The device according to claim 13, wherein
a surface of the p-type diamond layer is hydrogen-terminated.
